(19) United States
(12) Patent Application Publication
(10) Pub. No.: US 2024/0276945 A1
(43) Pub. Date: Aug. 22, 2024

(54) SYSTEM AND METHOD FOR REMOVING MANURE FROM A FLOOR IN A BARN FOR ANIMALS, AND, IN COMBINATION, A BARN FOR KEEPING ANIMALS AND A SYSTEM OF THIS TYPE

(71) Applicant: LELY PATENT N.V., Maassluis (NL)

(72) Inventors: Harm JORNA, Gouda (NL); Robin Andreas Albertus VAN KESTER, 's-Gravenzande (NL); Dogan ÖZMEN, Maassluis (NL); Michiel Adriaan VAN DORP, Hazerswoude-Rijndijk (NL)

(73) Assignee: LELY PATENT N.V., Maassluis (NL)

(21) Appl. No.: 18/571,508

(22) PCT Filed: Jul. 7, 2022
(86) PCT No.: PCT/IB2022/056292

§ 371 Date: Dec. 18, 2023

(30) Foreign Application Priority Data
Jul. 12, 2021 (NL) 2028702

(51) Int. Cl. A01K 1/01; B60L 53/12

(52) U.S. Cl. CPC A01K 1/0128; B60L 53/12; B60L 2200/40

(57) ABSTRACT

A system for removing manure from a floor in a barn for animals, such as cows, includes an autonomous manure removing vehicle which is provided with a drive system. The drive system includes at least one electric drive motor. An electronic control system is connected to the drive system for control thereof. A battery system for storing electrical energy is connected to the drive system and the control system. The system includes a charging station for charging the battery system of the manure removing vehicle. The charging station includes a transmitting body with a primary coil. The manure removing vehicle includes a receiving body with a secondary coil. The receiving body is arranged on a top side of the manure removing vehicle. The manure removing vehicle is maneuverable with respect to the transmitting body of the charging station in such a way that the primary coil of the transmitting body and the secondary coil of the receiving body are mutually aligned in order to wirelessly transfer electrical energy from the primary coil to the secondary coil for wireless charging of the battery system of the manure removing vehicle.

The invention relates to a system for removing manure from a floor in a barn for keeping animals, such as cow manure, using an electrically driven, autonomous manure removing vehicle. In this case, the “removal of manure” not only includes the taking up of manure from a floor, for example by sucking up, picking up, scooping up and the like, but also the moving of manure over a floor containing slotted holes, i.e. a “grid floor” or “slatted floor”, in order to remove this manure to a manure reservoir under the floor. With a grid floor, it is possible to remove the manure on the floor by pushing the manure through the slotted holes, so that the manure drops into the manure reservoir under the floor.

The Lely Discovery 120 Collector® is known. This is an autonomous manure removing vehicle for removing manure from the floor of a barn. The vehicle is situated in a highly soiled environment among the animals in the barn, as a result of which the vehicle becomes very soiled with manure and urine from the animals during use, and for example also with straw, sand and/or sawdust from the barn. The vehicle can find its way autonomously by means of an electronic control system with sensors, such as an ultrasound sensor and a gyroscope. On the basis of the signals detected by the sensors, the control system controls a drive system comprising electrical drive motors for the wheels of the vehicle. Consequently the vehicle can be steered and can travel along a desired route. The drive system and the control system are powered by a battery system on board the vehicle. The battery system is connected to electrically conductive charging strips which extend on the outside of the vehicle. In order to charge the battery system, the vehicle travels to a charging station with charging electrodes. In the charging station, the vehicle maneuvers in such a way that the charging strips on the outside of the vehicle make contact with the charging electrodes of the charging station and charging current can be supplied to the battery system.

However, for safety reasons, the charging current is limited. When the charging strips of the vehicle make contact with the charging electrodes of the charging station, there is a risk of an electric spark, while explosive manure gases may be present in the vicinity of the charging station. The charging current is limited in order to prevent an electric spark leading to an explosion. However, the lower the charging current, the longer it takes for the battery system to charge. Charging therefore takes a relatively long time, which adversely affects the capacity (in liters of manure removed per day).

It is an object of the invention to provide an improved system for removing manure from a floor in a barn with animals, in which, in particular, charging of the autonomous manure removing vehicle takes less time and at the same time reliability remains ensured.

This object is achieved according to the invention by a system for removing manure and/or urine from a floor in a barn for keeping animals, such as dairy cows, cows for meat production, pigs or goats, which system is provided with:
an autonomous manure removing vehicle for removing manure and/or urine from the floor in the barn, wherein the vehicle comprises:
   a drive system for driving the manure removing vehicle, which drive system is provided with at least one electric drive motor,
   an electronic control system which is connected to the drive system for control thereof,
   a battery system for storing electrical energy, which battery system is connected to the drive system and the control system,
a charging station for charging the battery system of the manure removing vehicle,
   wherein the charging station comprises a transmitting body with a primary coil, and the manure removing vehicle comprises a receiving body with a secondary coil, wherein the receiving body is arranged on a top side of the manure removing vehicle, and wherein the manure removing vehicle is maneuverable with respect to the transmitting body of the charging station in such a way that the primary coil of the transmitting body and the secondary coil of the receiving body are mutually aligned in a charging state in order to wirelessly transfer electrical energy from the primary coil of the transmitting body of the charging station to the secondary coil of the receiving body of the manure removing vehicle for wireless charging of the battery system of the manure removing vehicle.

The manure removing vehicle according to the invention is configured to autonomously travel at least one route among the animals in the barn. If it is desired to charge the battery system, the manure removing vehicle travels to the charging station. The charging station defines a charging position for the manure removing vehicle during charging of the battery system. When the vehicle is in the charging position, it is possible, according to the invention, for the primary coil of the transmitting body of the charging station and the secondary coil of the receiving body of the manure removing vehicle to be mutually aligned in the charging state for wireless energy transfer between them. In particular, the manure removing vehicle is at least partly maneuverable under the transmitting body of the charging station in such a way that the primary coil of the transmitting body is aligned over the secondary coil of the receiving body. In this case, the primary coil of the transmitting body of the charging station and the secondary coil of the receiving body of the manure removing vehicle are aligned above one another in the charging state.

In particular, the transmitting body comprises a transmitting plate with the primary coil and the receiving body comprises a receiving plate with the secondary coil. The transmitting plate and the receiving plate may each be formed by a round disk (“charging pad”), in particular having a diameter of 10 to 30 cm and/or a thickness of 1 to 2 cm. The transmitting body and the receiving body comprising such a “charging pad” may have a different suitable shape, such as a droplet shape, a rectangular shape or otherwise. The primary and secondary coil may each comprise one or more induction coils, for example a packet of induction coils. The term “coil” is to be understood as meaning a device which comprises one or more induction coils.

With the wireless charging system according to the invention eliminates the risk of electric sparking. During the wireless transfer of electrical energy from the transmitting body to the receiving body, there cannot be any spark formation, which could lead to dangerous situations in the presence of explosive manure gases. According to the invention, it is therefore possible to increase the charging current without compromising safety. As a result thereof, charging of the autonomous vehicle takes less time, so that the vehicle can spend more time driving around in order to perform the task of removing manure. This increases the capacity (in liters of manure removed per day).

At the same time, the reliability of charging the autonomous manure removing vehicle is ensured by the fact that the receiving body with the secondary coil is arranged on the top side of the vehicle. Firstly, the receiving body provided on the top side of the vehicle is less prone to soiling by manure and urine from the animals. The manure and urine, but also, for example, straw, sand and/or sawdust, lie on the floor in the barn. Soiling and the associated risks of corrosion are much greater on the underside of the vehicle which is close to the floor. Due to the fact that the receiving body with the secondary coil is situated on the top side of the vehicle, it is furthermore possible to charge the battery system irrespective of whether the vehicle in the charging station is limited by a wall on the left or on the right. The vehicle according to the invention can be charged both on the left and on the right next to a wall, thus making it possible to install the charging station in a barn in an optimum location. In addition, the risk of damage, in particular from kicks by cows, both from cows in cubicles which kick backwards and from standing cows, to the relatively fragile receiving body with the secondary coil is minimal, due to the fact that the receiving body has been arranged on the top side of the vehicle. Furthermore, the receiving body is very easily accessible on the top side of the vehicle for cleaning and maintenance work. Although the top side of the vehicle does not become soiled as quickly with manure, manure will nevertheless end up on the top side of the vehicle after prolonged use. This soiling can easily be removed on the top side. Yet another advantage is the fact that it is clearly visible how soiled the receiving body is—if the receiving body were arranged, for example, on the underside of the vehicle, soiling would not be immediately visible and the farmer would have to actively check the degree of soiling and, in addition, accessibility for the farmer is poor. Therefore, the charging system according to the invention is particularly reliable for use with a manure removing vehicle which moves among animals in a barn.

In an embodiment, the transmitting body of the charging station comprises a downwardly facing flat surface, wherein the receiving body of the manure removing vehicle comprises an upwardly facing flat surface, and wherein the transmitting body of the charging station and the receiving body of the manure removing vehicle are arranged in such a way that the downwardly facing flat surface of the transmitting body of the charging station is arrangeable over or on top of the upwardly facing flat surface of the receiving body of the manure removing vehicle.

In particular, the transmitting body and the receiving body are each at a height of at least 30 cm, in particular at least 50 cm, above the floor. Due to the location of the receiving body on top of the manure removing vehicle, the receiving body suffers less from soiling and corrosion, and the risk of damage from kicks by cows is also minimal. At the same time, the transmitting body and the receiving body are configured and arranged on the charging station and the manure removing vehicle, respectively, in such a way that they can be arranged over or on top of one another by maneuvering the vehicle in the charging station for wireless charging.

In an embodiment, the top side of the manure removing vehicle is defined by a substantially flattened top surface, wherein the receiving body extends along this top surface. The flattened top surface extends substantially horizontally. The flattened top surface forms a part of the outer contour of the vehicle, i.e. determines the total height of the manure removing vehicle, which is, for example, between 50 and 80 cm, such as is substantially 60 or 70 cm. The maximum height for a manure removing vehicle for travelling among cows is limited. When cows then relieve themselves, the top surface becomes soiled with manure at this height, but less so than other parts of the vehicle, such as the underside thereof. For the sake of clarity, it should be pointed out that the flattened top surface does not have to be completely flat, but may have a slightly rounded or spherical shape. The receiving body of the manure removing vehicle lies next to the flattened top surface. At this location, the receiving body suffers less from soiling and corrosion, and the risk of damage from kicks by cows is also minimal.

In an embodiment, the receiving body is arranged in a vertical central longitudinal plane of the manure removing vehicle. The manure removing vehicle is limited on either side by side walls. In the center between the side walls lies the vertical central longitudinal plane. The receiving body is placed on the top side of the manure removing vehicle in the center between the side walls. In other words, viewed in a 10 direction at right angles to the direction of travel of the manure removing vehicle straight ahead, the receiving body is situated in the center of the manure removing vehicle. If animals, such as cows, relieve themselves on the top side of the manure removing vehicle, manure may remain behind thereon. In practice, this manure collects mainly in elongate strips on the top side adjacent to the side walls. In the center, the top side of the manure removing vehicle is less prone to being soiled by manure. Therefore, the receiving body in the center of the manure removing vehicle suffers relatively little from soiling and corrosion by manure and/or urine. Incidentally, the receiving body may, in the longitudinal direction of the manure removing vehicle, i.e. in the direction of travel straight ahead, be situated both in the center and at the front or rear on the top side of the manure removing vehicle.

In an embodiment, the manure removing vehicle comprises a housing with an interior, in which the control system and/or the battery system are at least partly arranged, wherein the receiving body, viewed in a vertical direction, extends at least partly directly above the interior of the housing. The housing forms an electrical enclosure for accommodating electrical and/or electronic components of the manure removing vehicle, such as components of the control system and/or the battery system. If the receiving body is placed substantially directly above the housing, a short connection is possible which is, in addition, substantially sealed against soiling from the inside and outside of the manure removing vehicle. This is advantageous with regard to reliability.

In a particular embodiment, the housing comprises an access opening in order to make the interior thereof accessible, and a cover which is movable between a closed position, in which the access opening is closed by the cover, and an open position, in which the interior of the housing is accessible via the access opening, wherein the access opening and the cover extend on the top side of the manure removing vehicle and the receiving body is provided on the cover. In this case, the cover forms a part of the outer contour of the manure removing vehicle, for example in a front half of the manure removing vehicle. Incorporating the receiving body and the cover results in a compact design which is particularly reliable.

In an embodiment, the transmitting body is arranged on the charging station at a distance above the floor. For example, the transmitting body is suspended from the charging station at a height above the floor. If the transmitting body of the charging station is situated above the floor, the transmitting body is hardly susceptible to soiling from manure lying on the floor. The operation of the transmitting body of the charging station is therefore guaranteed. In addition, the charging station is preferably protected by a fence, so that the animals in the barn cannot get into or near the charging station, or hardly.

In this case, it is preferred if the transmitting body of the charging station is situated at a height which is adapted in such a way to the height of the receiving body of the manure removing vehicle that, by maneuvering the manure removing vehicle in the charging station, the transmitting body of the charging station is engageable by the receiving body of the manure removing vehicle, and the transmitting body and the receiving body are arrangeable over or on top of one another in order to wirelessly transfer electrical energy from the primary coil of the transmitting body to the secondary coil of the receiving body. The transmitting body and the receiving body are therefore situated at a distance above the floor, as a result of which the negative effect of soiling from manure is reduced and the primary coil and the secondary coil can be aligned with respect to one another in a reliable and accurate way.

In a particular embodiment, the receiving body of the manure removing vehicle, in particular the upwardly facing flat surface thereof, viewed in the direction of travel towards the charging station when the manure removing vehicle enters the charging station, is arranged slanting downwards with respect to the horizontal, wherein the transmitting body of the charging station, in particular the downwardly facing flat surface thereof, viewed in an opposite direction towards the manure removing vehicle, extends slanting upwards with respect to the horizontal. Therefore, the receiving body can engage reliably and accurately with the transmitting body when the manure removing vehicle enters the charging station.

In a preferred embodiment, the receiving body is fastened rigidly to the manure removing vehicle, wherein the transmitting body of the charging station is movable from a waiting state by engaging with the receiving body of the manure removing vehicle which enters the charging station, in such a way that the primary coil of the transmitting body and the secondary coil of the receiving body are aligned above one another in a charging state in order to wirelessly transfer electrical energy from the primary coil to the secondary coil. The transmitting body of the charging station is in particular pretensioned into the waiting state, for example by means of a spring device. The transmitting body of the charging station is movable from the waiting state, in which the transmitting body is suspended from the charging station so as to be substantially freely movable, by engaging with the receiving body of the manure removing vehicle which enters the charging station, until the transmitting body lies over or on top of the receiving body, so that electrical energy is wirelessly transferable from the primary coil of the transmitting body to the secondary coil of the receiving body. The manure removing vehicle which travels among the animals in the barn is more susceptible to soiling from manure than the charging station, which is situated at a fixed position in the barn. By providing the freedom of movement during alignment of the two charging bodies with respect to each other with the transmitting body of the charging station and fixedly securing the receiving body to the manure removing vehicle, the negative effect of soiling from manure is minimized. This is advantageous with regard to reliability and service life. In an embodiment, the primary coil of the transmitting body and the secondary coil of the receiving body are at a mutual distance apart which is less than 5 cm, preferably less than 3 cm, such as substantially 2 cm or less, when the primary coil of the transmitting body of the charging station and the secondary coil of the receiving body of the manure removing vehicle are aligned over one another in order to wirelessly transfer electrical energy from the primary coil to the secondary coil. The transmitting body and the receiving body are aligned with respect to each other in such a way that wireless energy transfer is possible between the primary coil of the transmitting body of the charging station and the secondary coil of the receiving body of the manure removing vehicle. As a result thereof, the battery system of the manure removing vehicle can be charged wirelessly in a reliable and efficient way.

The manure removing vehicle may be configured in various ways. In an embodiment, the manure removing vehicle comprises a manure slider or manure scraper for moving and/or scraping manure over the floor. While the manure removing vehicle is travelling, the manure slider slides over the floor of the barn. The manure slider is in contact with the floor in order to move and/or scrape any manure present thereon. With a solid barn floor, an amount of manure then accumulates in front of the manure slider, i.e. a “manure bath” is produced in front of the manure slider. The manure removing vehicle may comprise a manure feed device for feeding or introducing manure from the floor and moving the fed-in manure to a manure storage container. For example, the accumulated manure in front of the manure slider is sucked up or picked up, such as raised via a rotating input, and temporarily stored in the manure storage container. In other words, while travelling across the floor, the manure removing vehicle collects manure from the floor into the manure storage container.

The manure removing vehicle may furthermore comprise a manure discharge opening for discharging manure from the manure storage container which is arranged, in particular, in the bottom of the manure storage container. It is possible both for the manure discharge opening to be combined with the manure feed opening, i.e. the manure feed opening and manure discharge opening are formed by one and the same opening, and for the manure discharge opening to be a separate, second opening which is closeable, for example, by a controllable discharge valve. When the manure storage container is full, the manure feed device stops the in-feed of manure and the manure removing vehicle travels to a dump in order to empty the manure storage container. The dump comprises a dump opening which opens into a manure reservoir.

The charging station may comprise the dump opening. In this case, the charging station forms a dump at the same time, i.e. during the dumping operation, the battery system can be charged, which is efficient. Preferably, the dump opening is arranged in the floor for dumping manure from the manure discharge opening of the manure storage container through the dump opening into a manure reservoir which extends under the floor. When the manure discharge opening of the manure removing vehicle is situated over the dump opening, the manure from the manure storage container is discharged to the manure reservoir via the dump opening.

The charging station and/or the dump may each, separately or combined, also be situated outside the barn. Obviously, it is also readily possible for the charging station and the dump to be separate from each other, i.e. the charging station is situated at a distance from the dump. For example, the vehicle first travels to the dump in order to empty the manure storage container, and subsequently from the dump to the charging station in order to charge the battery system. In this case, the dump may be in the open air, while the charging station is arranged, for example, in the barn.

According to the invention, it is furthermore possible for the manure removing vehicle to be configured for use with a grid floor or slatted floor, i.e. a floor comprising slots and a manure reservoir or manure pit under the floor of the barn for receiving manure which has been moved through the slots by the scraping action of the manure removing vehicle. In other words, while the manure removing vehicle is travelling, the manure slider slides over the floor of the barn in order to force the manure through the slots which then drops into the manure reservoir on account of the force of gravity. In this way, the manure is removed from the grid floor.

The invention also relates to, in combination, a barn for keeping animals, such as dairy cows or cows for meat production, and a system as described above. In particular, the manure removing vehicle and the charging station are situated in the barn, i.e. in the space for keeping the animals. As has already been mentioned above, the charging station may however also be situated outside the barn.

The invention furthermore relates to a method for removing manure and/or urine from a floor in a barn for keeping animals, such as dairy cows, cows for meat production, pigs or goats, wherein use is made of a system as described above, and wherein the method comprises:
moving the autonomous manure removing vehicle over the floor of the barn in order to remove manure from the floor,
moving the manure removing vehicle to the charging station, and
wirelessly charging the battery system of the manure removing vehicle in the charging station by wireless transfer of electrical energy from the primary coil of the transmitting body of the charging station to the secondary coil the receiving body of the vehicle.

If the manure removing vehicle is configured to have a manure storage container for temporarily collecting manure which has been removed from the floor, and the manure removing vehicle travels to the dump in order to empty the manure storage container when it is full, the battery system is in particular charged during and/or after the dumping of the manure.

The method according to the invention has the same technical effects and advantages as described above with respect to the system according to the invention.

The invention will now be explained in more detail with reference to the appended figures.

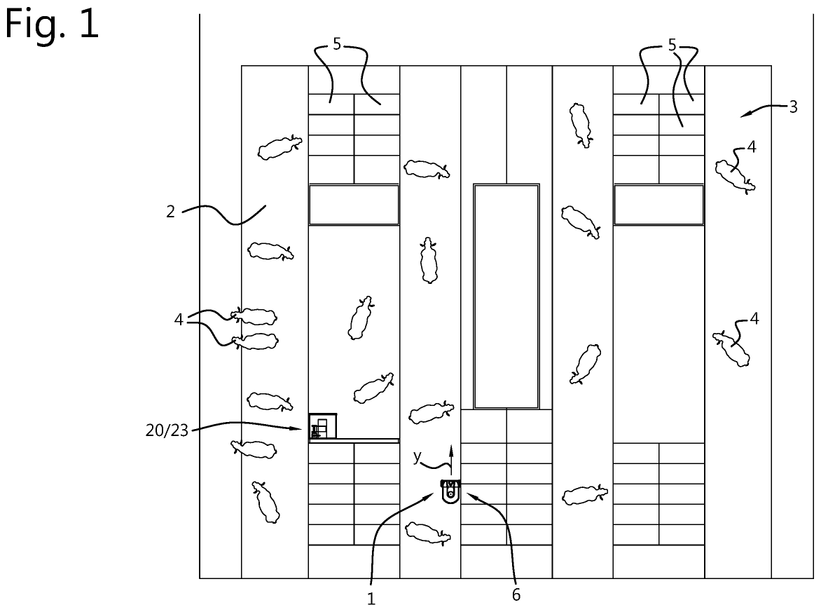

FIG. 1 shows a schematic top view of a barn with a system according to the invention, wherein the system is provided with an autonomous manure removing vehicle and a charging station that forms a dump.

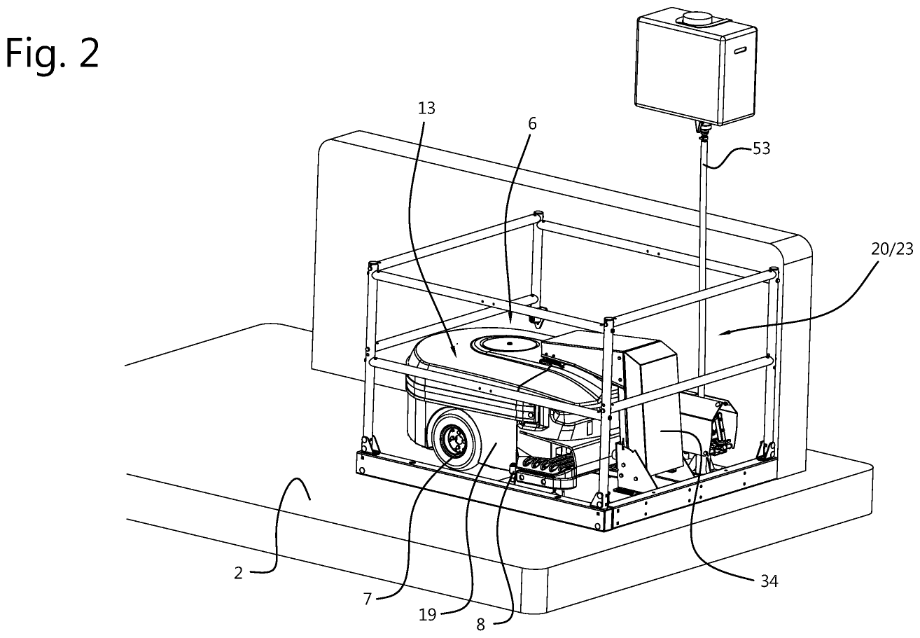

FIG. 2 shows a perspective view of the manure removing vehicle in the charging station of the system shown in FIG. 1.

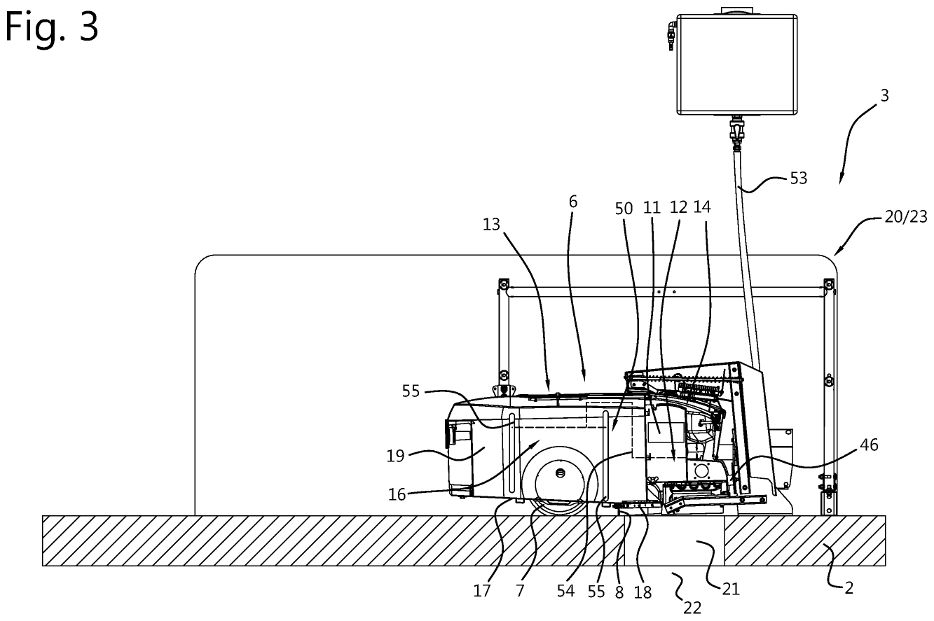

FIG. 3 shows a partially cut-away side view of the manure removing vehicle shown in FIG. 2 in the charging station.

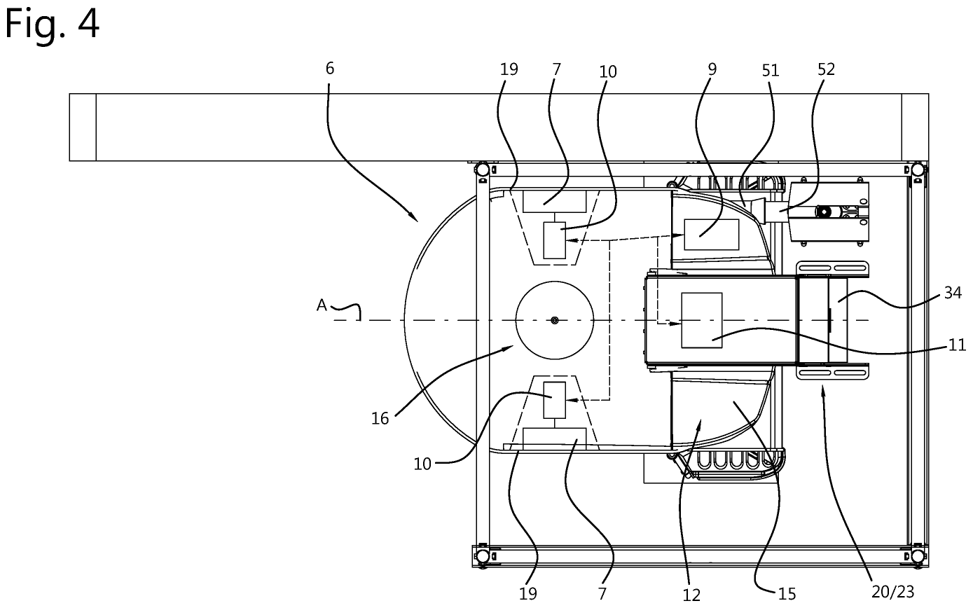

FIG. 4 shows a top view of the manure removing vehicle shown in FIG. 3 in the charging station.

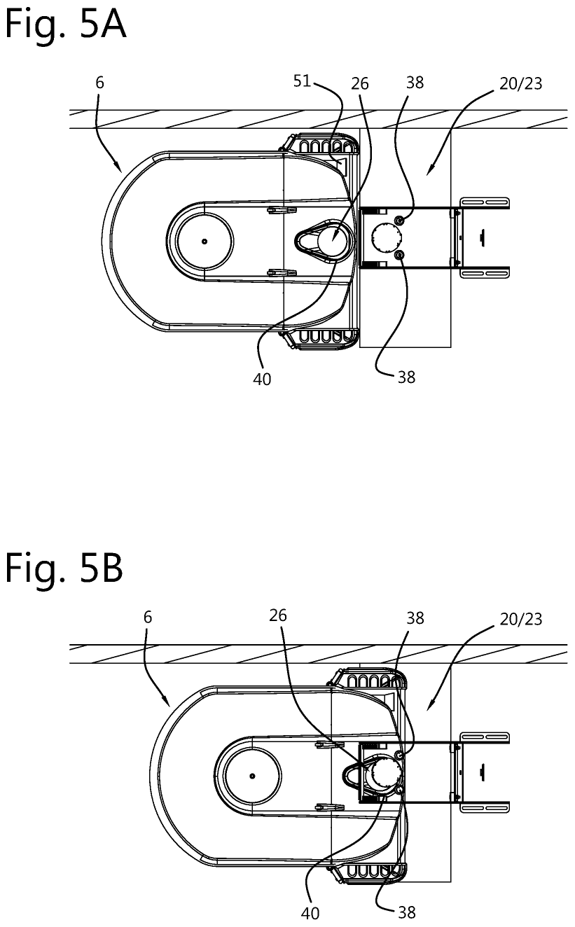

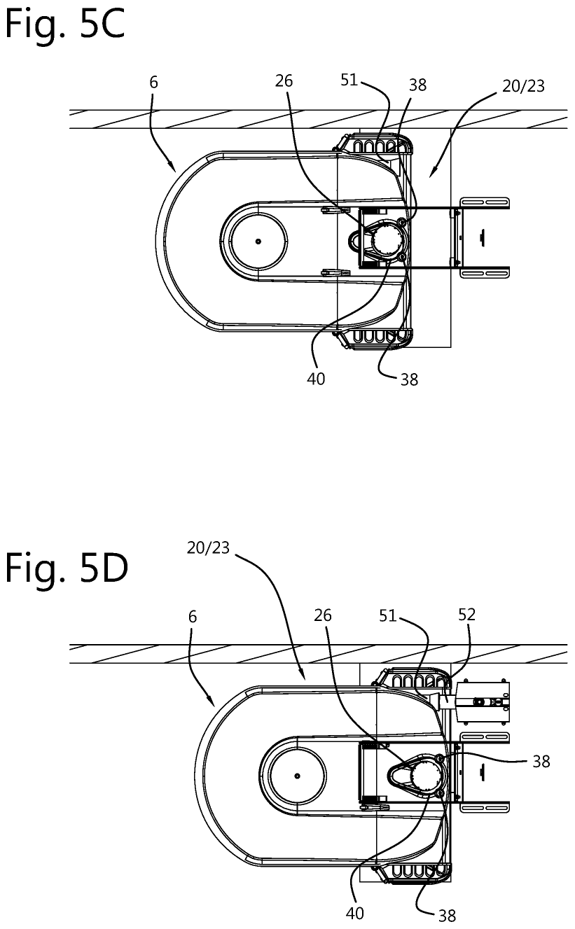

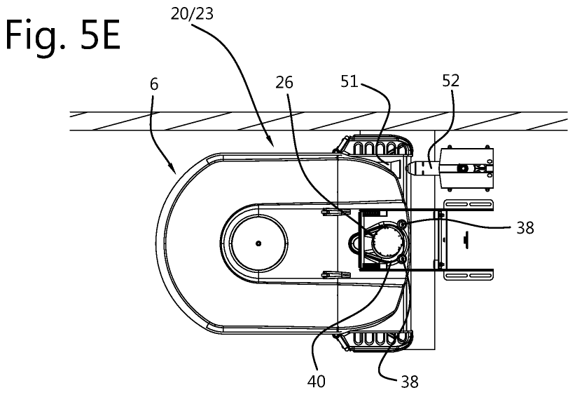

FIGS. 5A-5E show top views of various steps in aligning a receiving body of the manure removing vehicle relative to a transmitting body of the charging station for the system shown in FIGS. 1-4.

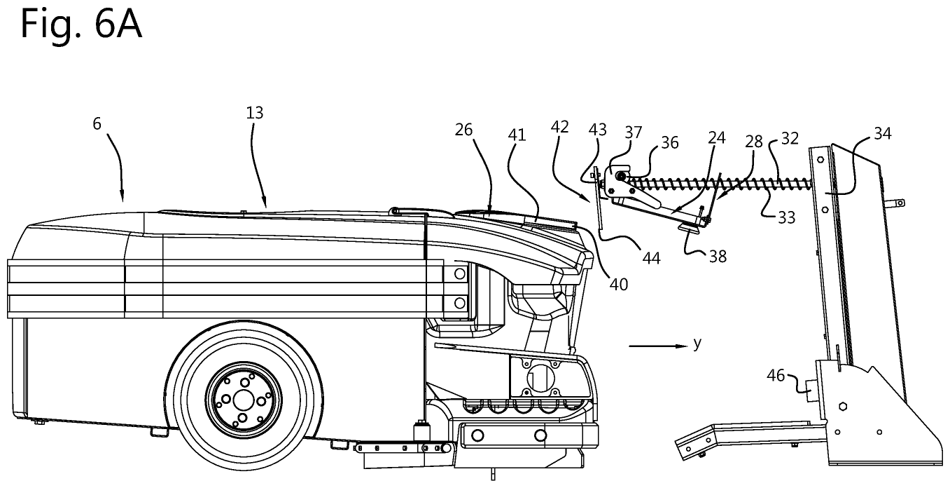

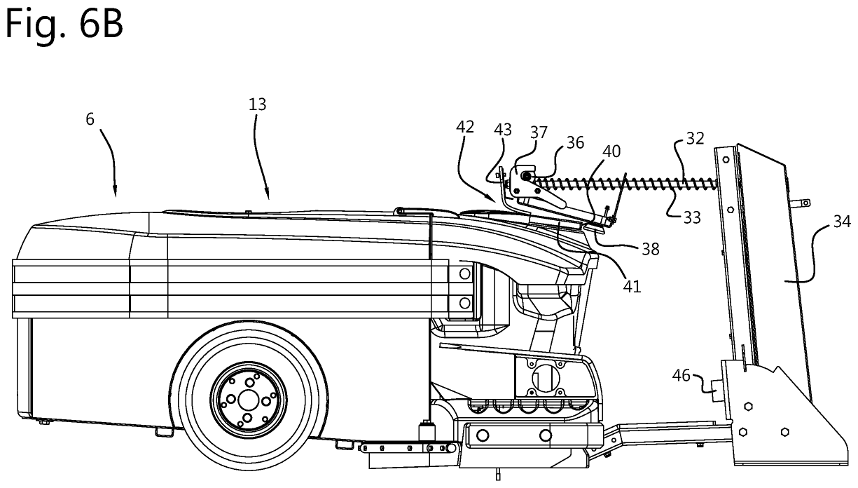

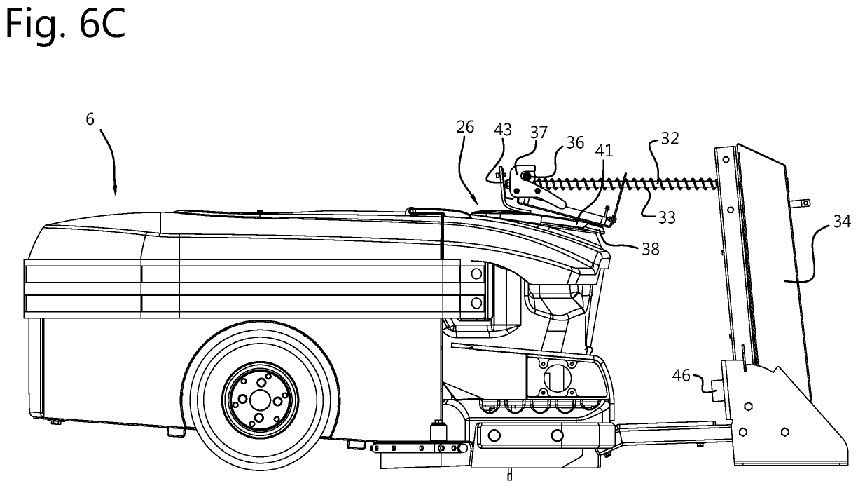

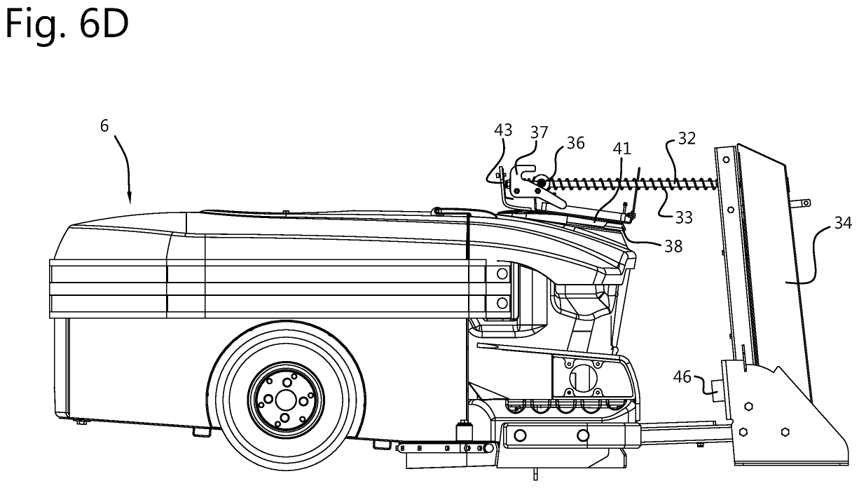

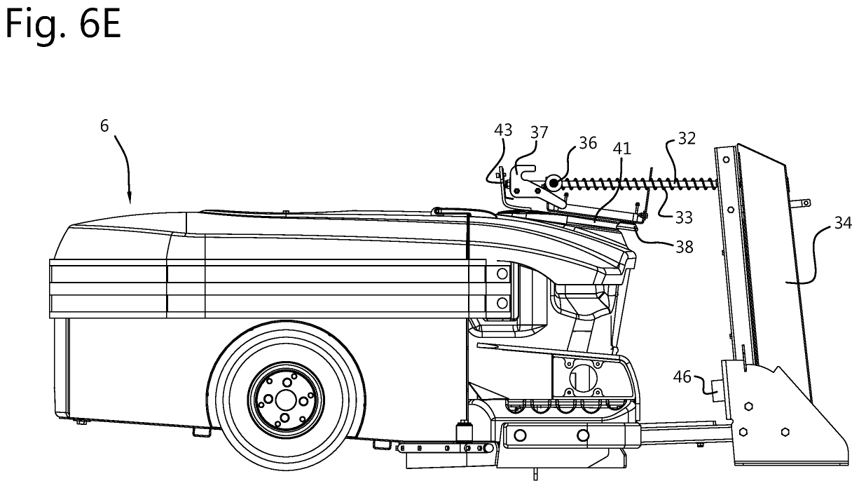

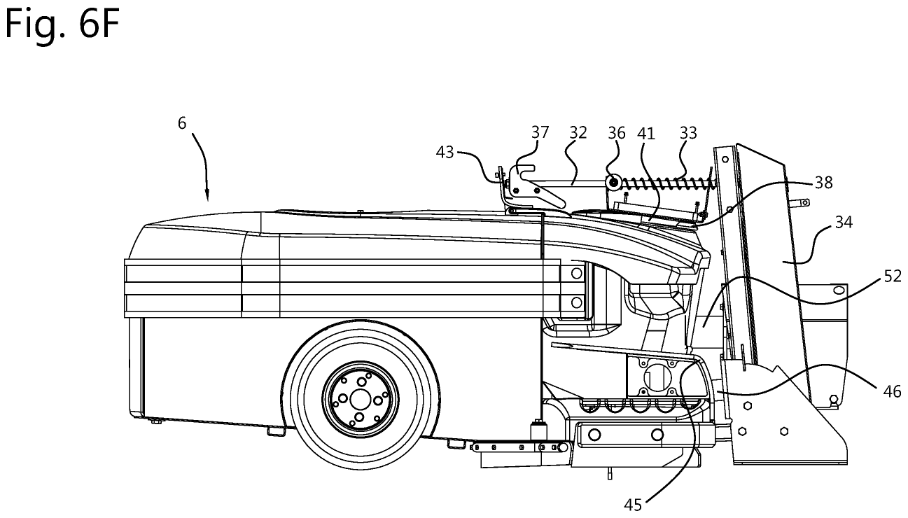

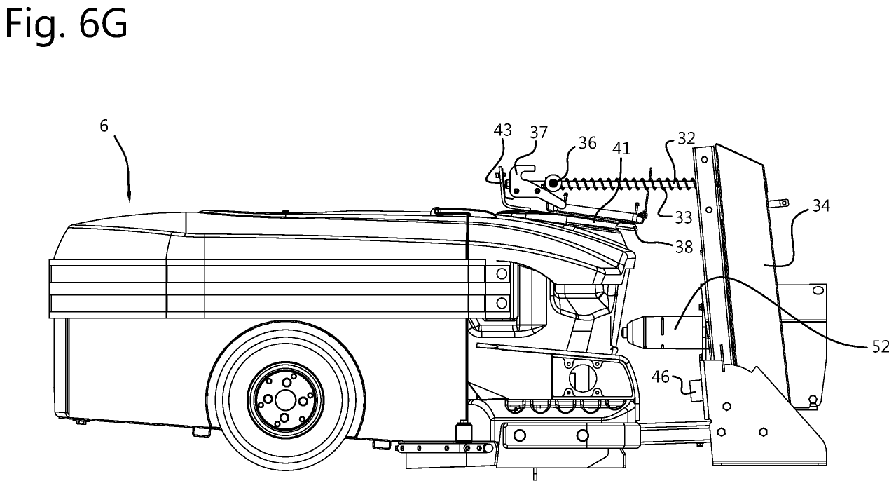

FIGS. 6A-6G show side views of various steps in aligning a primary coil of a transmitting body of the charging station relative to a secondary coil of a receiving body of the manure removing vehicle for the system shown in FIGS. 1-4, wherein the charging station is partially cut away.

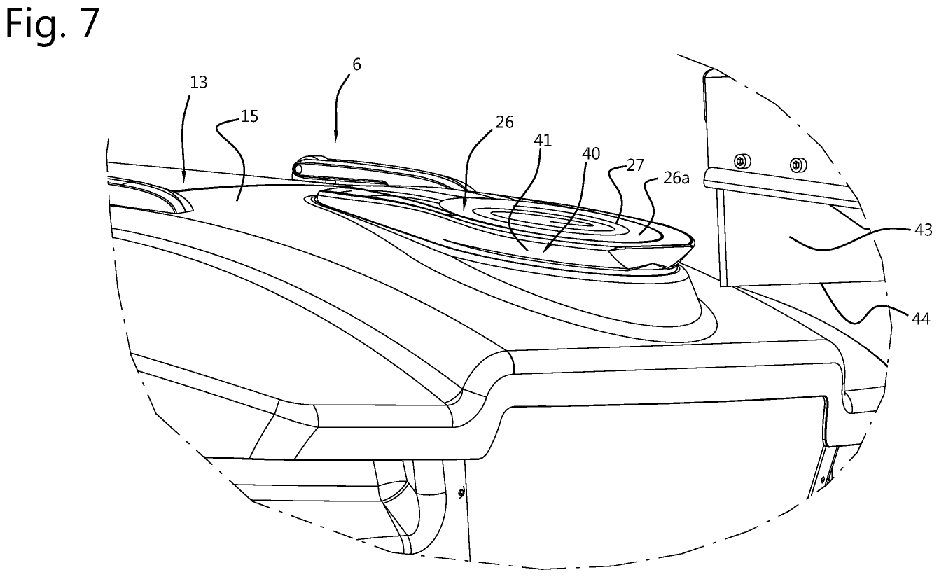

FIG. 7 shows an enlarged perspective view of the receiving body of the manure removing vehicle of the system according to FIGS. 1-6.

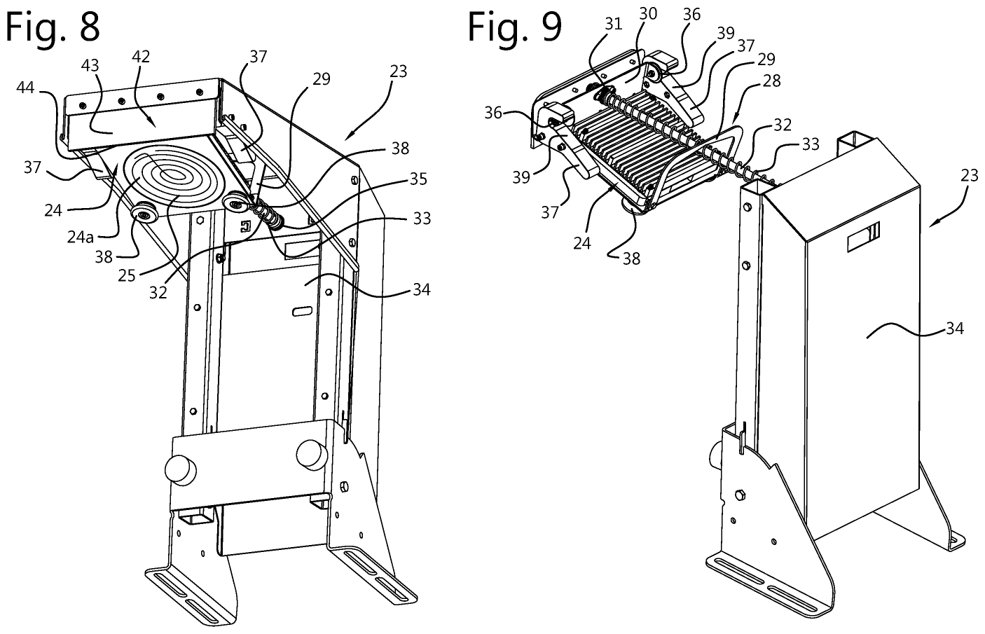

FIGS. 8 and 9 show perspective views of the charging station of the system according to FIGS. 1-6, wherein FIG. 9 is partially cut away.

FIG. 1 shows a system 1 for the removing of manure and/or urine from a solid floor 2 in a barn 3 that is configured as a typical loose housing barn for cows with cubicles 5. On the floor 2 there is manure and urine from the animals 4, and for example also straw, sand and/or sawdust, with which the cubicles 5 are lined. In this exemplary embodiment the system 1 comprises an autonomous manure removing vehicle 6 for removing manure. The manure removing vehicle 6 is located on the floor 2 among the animals 4. The manure removing vehicle 6 is supported on the floor 2 by means of two wheels 7 and a manure slider 8 (see FIGS. 3 and 4). The manure removing vehicle 6 may, however, also be supported in some other way, for example with a front wheel or a supporting element, such as a sliding block.

The manure slider 8 is configured for moving and/or scraping manure over the floor 2. During travel of the manure removing vehicle 6 over the floor 2, the manure slider 8 is in contact with the floor 2 in order to move and/or scrape manure that is present thereon. The manure slider 8 has for example a flexible bottom edge that scrapes over the floor 2. With the solid barn floor 2, a quantity of manure is then accumulated or pushed up in front of the manure slider 8, i.e. a “manure bath” forms in front of the manure slider 8. In this exemplary embodiment the manure slider 8 forms part of a manure feed device for feeding or introducing manure from the floor 2 and moving the fed-in manure to a manure storage container 16 (see FIG. 3), which defines an interior, in which manure can be collected temporarily.

The manure removing vehicle 6 is unmanned and self-propelled. The manure removing vehicle 6 can find its way autonomously by means of an electronic control system 9 (see FIG. 4) with sensors, such as an ultrasonic sensor and a gyroscope. On the basis of the signals detected by the sensors, the control system 9 controls a drive system with electric drive motors 10 for the wheels 7 of the manure removing vehicle 6. Because the wheels 7 are controllable independently of each other, the manure removing vehicle 6 can be steered and can travel a desired route through the barn 3.

The drive system and the control system 9 are supplied by a battery system 11 for storing electrical energy on board the manure removing vehicle 6. The battery system 11 comprises one or more rechargeable batteries, in particular 24V lithium batteries. The battery system 11 and electronic components of the control system 9, which are not resistant to manure or urine, are enclosed in a housing 12 of the manure removing vehicle 6. The housing 12 forms an electrical enclosure for housing electrical and/or electronic components of the manure removing vehicle 6.

In this exemplary embodiment this housing 12 is fitted substantially above and in front of the manure slider 8. The housing 12 comprises an access opening 14 at the top, for example for maintenance work. The access opening 14 is closable by a hinged cover 15. The cover 15 is movable between a closed state, in which the access opening 14 is closed by the cover 15, and an open state, in which the interior of the housing 12 is accessible via the access opening 14.

The manure storage container 16 is located behind the housing 12. The manure storage container 16 comprises a bottom 17, which slants toward a manure feed and discharge opening 18, which is arranged at a lowest level of the bottom 17. The interior of the manure storage container 16 is further delimited by the inside of the two side walls 19 of the manure removing vehicle 6. In each side wall 19 there is a wheel housing for receiving a wheel 7 and the associated electric drive motor 10 (see FIGS. 2 and 4).

Although in this exemplary embodiment the manure storage container 16 has a single manure feed and discharge opening 18, i.e. manure taken up from the floor 2 is fed via this opening 18 to the manure storage container 16 and during emptying of the manure storage container 16 the collected manure leaves the manure storage container 16 via the same opening 18, it is also possible for the manure removing vehicle 6 to have two separate openings: a first opening for supply of manure and a second opening for discharge of manure.

During travel, manure collects on the floor 2 in front of the manure slider 8, which extends partially around the manure feed opening and outlet 18. A “manure bath” is formed in front of the manure slider 8. In this exemplary embodiment the manure feed device comprises a vacuum pump in order to generate a partial vacuum in the interior of the manure storage container 16, so that manure in the manure bath is sucked up from the floor 2 and flows via the manure feed and discharge opening 18 to the interior of the manure storage container 16. The manure is stored therein until the manure storage container 16 gets substantially full.

A manure feed device for sucking up manure is described in detail in WO 2013/010785 A1, the contents of which are incorporated by reference in the present description, and will not be explained further. It should be noted that the manure feed device may also have some other configuration. Instead of sucking up manure as described above, the manure feed device may for example comprise a mechanical pick-up mechanism for picking up or scooping up manure from the floor 2. Then the manure is for example moved upward by means of a rotor, and then ends up inside the manure storage container via a manure feed opening.

If the manure storage container 16 is full, the manure feed device stops the in-feed of manure and the manure removing vehicle 6 travels to a dump 20 in order to empty the manure storage container 8. At the dump 20, a dump opening 21 is installed in the floor 2, which opens into a manure reservoir or manure pit 22, which extends underneath the floor 2. If the manure removing vehicle 6 with the manure feed and discharge opening 18 is positioned above the dump opening 21 (see FIG. 3), the control system 9 switches off the vacuum pump, so that the partial vacuum in the interior of the manure storage container 16 disappears and the manure flows under the effect of gravity from the manure storage container 16, through the dump opening 21, and into the manure reservoir 22.

The discharge of the manure may, however, also have some other configuration. In the case of a manure removing vehicle that picks up manure and brings it via a rotor upward to the manure storage container, for example a separate manure discharge opening is provided, which is closable by a controllable discharge valve. At the dump, the discharge valve for example swivels away to open the manure discharge opening, so that the manure drops from the manure storage container into the manure reservoir.

Although the manure removing vehicle 6 described above is configured for receiving the manure and moving the received manure to a dump 20, the autonomous manure removing vehicle may, however, also be configured for moving and/or scraping manure through slot-shaped openings of a “grid floor” or “slatted floor” of the barn (not shown). In other words, in this case, during travel of the manure removing vehicle the manure slider scrapes over a grid floor of the barn to push the manure through the slots, which then drops into the manure reservoir under the floor under the effect of gravity.

The system 1 according to the invention further comprises a charging station 23 for wireless charging of the battery system 11 of the manure removing vehicle 6. If it is desired to charge the battery system 11, the manure removing vehicle 6 travels to the charging station 23. The charging station 23 defines a charging position for the manure removing vehicle 6 during charging of the battery system 11.

In this exemplary embodiment the charging station 23 comprises the dump opening 21, i.e. the charging station 23 and the dump 20 are integrated in this case. During discharge of the manure, the battery system 11 of the manure removing vehicle 6 can be charged. Obviously it is also possible that the charging station 23 does not form a dump. Also, the charging station 23 and/or the dump 20, each separately or combined, may be placed outside the barn 3.

As shown in FIGS. 8 and 9, the charging station 23 comprises a transmitting body 24, which is provided with a transmitting plate 24a with a primary coil 25 (shown schematically in FIG. 8). The transmitting plate 24a is mounted adjacent to a downward facing flat surface of the transmitting body 24. The flat surface of the transmitting body 24 of the charging station 23, viewed in a direction opposite to the forward direction of travel y as the manure removing vehicle 6 enters the charging station 23, extends slanting upward relative to the horizontal.

The manure removing vehicle 6 comprises a receiving body 26, which is provided with a receiving plate 26a with a secondary coil 27 (shown schematically in FIG. 7). The receiving plate 26a is applied adjacent to an upward facing flat surface of the receiving body 26. The flat surface of the receiving body 26 of the manure removing vehicle 6, viewed in the forward direction of travel y toward the charging station 23, extends slanting downward relative to the horizontal.

The transmitting plate 24a and the receiving plate 26a are each formed by a round disk (“charging pad”), in this exemplary embodiment with a diameter of about 16 cm and a thickness of about 2 cm. The charging pads 24a, 26a are incorporated in the transmitting body 24 and the receiving body 26. The charging pads 24a, 26a comprise the primary coil 25 or the secondary coil 27, respectively. The primary and secondary coils 25, 27 may each comprise one or more induction coils, for example a stack of induction coils.

The receiving body 26 is fastened rigidly to an upper side 13 of the manure removing vehicle 6. The upper side 13 of the manure removing vehicle 6 is defined by a substantially flattened upper surface. The receiving body 26 lies along said upper surface. At this location, the receiving body 26 is less liable to fouling and corrosion, and the risk of damage through trampling by cows is also minimal.

In this exemplary embodiment, the flattened upper surface has a somewhat rounded or round shape, but the upper surface may also define a substantially horizontal plane (not shown). The upper surface forms a portion of an outermost wall, i.e. the outer contour of the manure removing vehicle 6. The upper surface determines the height of the manure removing vehicle 6, which in this exemplary embodiment is about 60 cm.

As shown in FIG. 7, in this exemplary embodiment the receiving body 26 is mounted on the cover 15, which defines a portion of the flattened upper surface. Viewed in the vertical direction, the receiving body 26 is located directly above the interior of the housing 12. As a result, a short connection to the control system 9 and the battery system 11 is possible, while said connection in addition runs exclusively in a region that is closed off from fouling by manure, urine and the like.

The receiving body 26 is, moreover, placed in a vertical central longitudinal plane A of the manure removing vehicle 6 (see FIG. 4). The vertical central longitudinal plane A lies centrally between the side walls 19 of the manure removing vehicle 6. In other words, the receiving body 26 is placed at the top of the manure removing vehicle 6 centrally between the side walls 19. Viewed in a direction transverse to the straight forward direction of travel y of the manure removing vehicle 6, the receiving body 26 is located in the middle of the manure removing vehicle 6.

If animals 4 relieve themselves on the upper side 13 of the manure removing vehicle 6, manure may remain thereon. In practice this manure collects in particular in elongated strips on the upper side 13 adjacent to the side walls 19. In the middle, the upper side 13 of the manure removing vehicle 6 is less fouled with manure. Consequently, the receiving body 26 in the middle of the manure removing vehicle 6 has relatively little exposure to fouling and corrosion by manure.

In order to charge the battery system 11 wirelessly, the primary coil 25 of the transmitting body 24 and the secondary coil 27 of the receiving body 26 are mutually aligned in a charging state, in which electrical energy is transferable wirelessly from the primary coil 25 to the secondary coil 27. The height of the downward facing flat surface of the transmitting body 24 is adapted to the height of the upward facing flat surface of the receiving body 26 of the manure removing vehicle 6 in such a way that these flat surfaces can be brought over and/or on each other in the charging state.

The transmitting plate 24a and the receiving plate 26a lie on top of one another in the charging state. For reliable and efficient wireless energy transfer it is desirable to position the primary coil 25 of the transmitting body 24 close to the secondary coil 27 of the receiving body 26, in particular at a distance apart of for example max. 1 or 2 cm. Alignment is shown in steps in FIGS. 5A-5D and 6A-6F, while FIGS. 7-9 illustrate further details of the receiving body 26 and the transmitting body 24.

In order to align the flat surfaces of the transmitting body 24 and the receiving body 26 reliably on top of each other, first the receiving body 26 is cleaned in order to remove most of the manure and other fouling thereon. After all, during use, the receiving body 26 of the manure removing vehicle 6 becomes (very) fouled with manure from the animals 4, often also in combination with urine, straw, sand and/or sawdust, which lie on the floor 2. After a time the manure becomes hard (“caked”). There may also be pieces or lumps in the manure. In consequence, the receiving body 26 is usually covered with a layer of manure when the manure removing vehicle 6 enters the charging station 23.

This manure renders it more difficult to arrange the flat surfaces of the transmitting body 24 and receiving body 26 on top of each other. In order to align the primary coil 25 of the transmitting body 24 and the secondary coil 27 of the receiving body 26 mutually in the charging state, in which electrical energy is transferable wirelessly from the primary coil 25 to the secondary coil 27 for wireless charging of the battery system 11, the charging station 23 comprises a cleaning device 42 for removing manure, urine and the like from the receiving body 26 while the manure removing vehicle 6 enters the charging station 23 and before the primary coil 24a of the transmitting body 24 and the secondary coil 26a of the receiving body 26 are mutually aligned in the charging state (see FIGS. 6A, 6B and 8).

Although the receiving body 26 does not have to be completely clean, the cleaning device 42 removes the fouling by manure and the like to a sufficient degree from the receiving body 26 to make it possible for the primary coil 25 of the transmitting body 24 and the secondary coil 27 of the receiving body 26 to be mutually aligned in the charging state. After cleaning by the cleaning device 42, manure or other fouling no longer impedes alignment in the charging state. Moreover, owing to the cleaning device 42, the manure removing vehicle 6 entrains considerably less manure into the charging station 23, so that the transmitting body 24 of the charging station 23 also becomes fouled less quickly.

The cleaning device 42 comprises a scraping element 43 for scraping manure from the flat surface of the receiving body 26 while the manure removing vehicle 6 travels forward in the direction of travel y into the charging station 23. The scraping element 43 is made of a flexible plastic, which in this exemplary embodiment comprises polyurethane. The scraping element 43 comprises, on the underside thereof, a scraping edge 44, which comes into contact with the flat surface of the receiving body 26 when the manure removing vehicle 6 travels under the scraping element 43 and into the charging station 23. The scraping edge 44 forms a substantially horizontal, straight bottom edge, which extends substantially transversely relative to the direction of travel y of the manure removing vehicle 6.

As the scraping edge 44 moves over the flat surface of the receiving body 26 to remove manure, elastic deformation of the scraping edge 44 occurs. During contact with the flat surface of the receiving body 26, the scraping edge 44 is bent, so that during scraping, the scraping edge 44 exerts a compressive force on the receiving body 26. Manure is removed while the bent scraping edge 44 of the scraping element 43 moves over the flat surface of the receiving body 26. When the manure removing vehicle 6 is driven away from the charging station 23 and the scraping edge 44 no longer makes contact, the scraping element 43 bends back to the original shape as shown in FIG. 8. Optionally, the cleaning device 42 comprises a water device for application of water on the receiving body 26, which for example is configured as a water nozzle (not shown). The water nozzle sprays water on the flat surface of the receiving body 26 before the scraping element 43 scrapes over this flat surface to remove manure. By supplying water to manure that is present as fouling on the flat surface of the receiving body 26, the scraping element 43 can remove this manure more easily and more effectively.

Only after the flat surface of the receiving body 26 has been cleaned and the manure removing vehicle 6 has then driven further into the charging station (see FIGS. 5B and 6C), the receiving body 26 of the manure removing vehicle 6 engages on the transmitting body 24 of the charging station 23, which is in a waiting state or initial state. The receiving body 26 of the manure removing vehicle 6 then comes into contact with the transmitting body 24 of the charging station 23.

The transmitting body 24 is pretensioned to the waiting state by means of a spring 33. As shown in FIGS. 8 and 9, the transmitting body 24 is fastened to a slide 28 of the charging station 23, which is suspended movably on a carrying bar 32 at a height above the floor 2. In this exemplary embodiment, the slide 28 comprises a carrying bracket 29 and a supporting plate 30 with an opening 31. The carrying bar 32 passes with clearance through the opening 31, under the carrying bracket 29, and is received with clearance in an opening 35 of a carrying frame 34 of the charging station 23. As a consequence of this clearance in the opening 35 of the carrying frame 34, the carrying bar 32 is somewhat tiltable relative to the carrying frame 34.

On either side of the carrying bar 32, the slide 28 comprises in each case a bush 36. The bushes 36 are receivable in receiving jaws 37, which are fastened to the carrying frame 34. The receiving jaws 37 form a front stop for the slide 28 with the transmitting body 24 fastened thereon. The front stop determines a front position for the transmitting body 24. During alignment, the slide 28 is movable over a distance backwards to a rearmost position, which is defined in that the manure removing vehicle 6 cannot travel further than until a bumper 45 on the front of the manure removing vehicle 6 comes into contact with a stop of the charging station 23, which in this exemplary embodiment is formed by two buffers 46 (see FIGS. 6F and 8).

The spring 33 is pushed onto the carrying bar 32 and is pretensioned between the supporting plate 30 and the carrying frame 34, so that the bushes 36 of the slide 28 are received in the receiving jaws 37 with a pretensioning force. The transmitting body 24 is then in the waiting state. The transmitting body 24 consequently always returns to the same accurately defined position when the manure removing vehicle 6 has left the charging station 23. As a result, during alignment the transmitting body 24 always begins at the same position that corresponds to the waiting state.

The transmitting body 24 is substantially freely movable from the waiting state, against the action of the spring 33. “Freely movable” is understood to mean that the transmitting body 24, on moving from the front position, which is determined by the front stop formed by the receiving jaws 37, to the rearmost position, which is determined by contact of the manure removing vehicle 6 against the buffers 46, is movable relative to the carrying frame 34 of the charging station 23 to adjust the position and orientation of the transmitting body 24 to the receiving body 26 of the manure removing vehicle 6 while the manure removing vehicle 6 enters the charging station 23 and the receiving body 26 engages on the transmitting body 24.

The transmitting body 24 may perform a motion of translation in the direction of travel y, so that the bushes 36 are released from the receiving jaws 37. The transmitting body 24 may also perform a motion of translation in a direction transverse to the direction of travel y, i.e. to the left and right. Furthermore, the transmitting body 24 may swivel to the left and right about a substantially vertical swivel axis through displacement of the carrying bracket 29 over the carrying bar 32, and rotate slightly to the left and right about the carrying bar 32.

The transmitting body 24 further comprises two centering bosses 38, which are arranged on either side of the carrying bar 32. The centering bosses 38 are located in angular regions to the left and right of the transmitting body 24, so that the flat surface that is contiguous with the transmitting plate 24a remains free, i.e. the flat surface of the receiving body 26 can be applied thereto. The centering bosses 38 have an undercut shape. The undercut shape prevents the transmitting body 24 going beyond the receiving body 26 while the manure removing vehicle 6 travels forward into the charging station 23 in the direction of travel y.

As shown in FIG. 7, the receiving body 26 comprises, on a front side thereof, a centering edge 40, which projects upward, substantially transversely from the cover 15 of the manure removing vehicle 6. The centering edge 40 forms a vertical collar, which partially surrounds the receiving plate 26a. Viewed in a direction opposite to the forward direction of travel y, i.e. backward from the front of the manure removing vehicle 6, the centering edge 40 on either side of the central axis of the receiving plate 26a runs away in an outward direction. In this exemplary embodiment the centering edge 40 has roughly the shape of a semicircle at the front of the receiving body 26. As a result, the centering edge 40 is self-aligning. The centering edge 40 further comprises a groove 41, which is configured to interact with the undercut centering bosses 38 of the transmitting body 24.

The height of the groove 41 of the centering edge 40 of the receiving body 26 and the height of the centering bosses 38 of the transmitting body 24 are matched to each other, i.e. as the manure removing vehicle 6 enters the charging station 23, the centering edge 40 first comes into contact with at least one of the centering bosses 38 of the transmitting body 36 in the waiting state. The undercut shape of this centering boss 38 is received in the groove 41, so that the transmitting body 24 does not shoot back over the receiving body 26 to the waiting state (see FIGS. 5B and 6C). With further travel of the manure removing vehicle 6, the other centering boss 38 also engages in the groove 41 (see FIG. 5C). In other words, the groove 41 of the centering edge 40 is caught by the centering bosses 38 of the transmitting body 24. The centering bosses 38 then engage in the groove 41 of the centering edge 40 on either side of the central axis of the receiving plate 26a. Because the centering edge 40 is of semicircular shape, the transmitting body 24 is self-aligning, i.e. the transmitting body 24 performs a motion of translation sideways, i.e. transversely to the direction of travel y, for accurate alignment.

By means of the centering bosses 38, the centering edge 40 forces the transmitting body 24 out of the waiting state, against the action of the pretension. The bushes 36 then move from the receiving jaws 37 and down over tracks or paths 39, while the carrying bar 32 tilts slightly downward relative to the opening 35 in the carrying frame 34 (see FIG. 6D). As a result, the flat surface of the transmitting body 24 also tilts against the flat surface of the receiving body 26, so that the transmitting plate 24a and the receiving plate 26a end up being substantially parallel to each other. The manure removing vehicle 6 is thereby maneuvered under the transmitting body 24 of the charging station 23 in such a way that the primary coil 25 of the transmitting body 24 is aligned in the charging state above the secondary coil 27 of the receiving body 26.

Since the transmitting body 24 is moved against the action of the pretension, the flat surfaces of the transmitting body 24 and receiving body 26 are pressed against each other in the charging state. Also owing to the weight of the slide 28 with the transmitting body 24, the flat surface of the transmitting body 24 “falls” firmly against the flat surface of the receiving body 26.

If the manure removing vehicle 6 travels further after reaching the charging state, the flat surfaces of the transmitting body 24 and the receiving body 26 remain lying on each other, while the slide 28 with the transmitting body 24 slides further over the carrying bar 32 in the direction of travel y. The bushes 36 then become free from the tracks 39 (see FIG. 6E). As mentioned above, the manure removing vehicle 6 may continue its travel until the bumper 45 at the front thereof comes into contact with the two buffers 46 of the carrying frame 34 of the charging station 23 (see FIGS. 6F and 8).

The manure removing vehicle 6 further comprises a water system 50, which is configured for spraying water on the floor 2 (shown schematically in FIG. 3). It is beneficial to wet the floor 2 to promote removal of manure from the floor 2. The water system 50 is optional. As can be seen in FIG. 4, in this exemplary embodiment the water system 50 comprises a water feed connection 51 for feeding water to the water system 50. The water feed connection 51 is couplable to a water supply connection 52, which is located at the charging station 23. The water supply connection 52 is for example connected to a water main 53 or a water buffer tank (not shown).

The water feed connection 51 of the manure removing vehicle 6 is connected by means of a pipe system 54 to two water reservoirs 55 for receiving water. In this exemplary embodiment the water reservoirs 55 are formed as flexible water bags, as is also described in WO 2017/069615 A1. In FIG. 3 the water bags 55 are not filled with water and so are substantially flat. When the water bags 55 are filled with water, the volume of the water bags 55 increases. Obviously it is possible to use just one water reservoir, and the water reservoir may be configured differently, for example as a plastic or metal tank (not shown).

By means of the pipe system 54, the water reservoirs 55 are further connected to one or more spray heads for spraying water on the floor 2 (not shown). For example, a spray head of the water system 50 is fitted on a front side of the manure removing vehicle 6, wherein this spray head sprays water on the floor 2 in front of the manure removing vehicle 6 while the manure removing vehicle 6 travels forward. In other words, this spray head always sprays water on an area of the floor 2 onto which the manure removing vehicle 6 travels. Furthermore, the water system 50 may comprise a further spray head, which for example is configured to spray water on the area of the floor 2 behind the manure removing vehicle 6.

The water supply connection 52 is omitted in FIGS. 5A-5C and 6A-6E, but is shown in FIGS. 5D, 5E, 6F and 6G, which show the manure removing vehicle 6 during charging of the battery system 11 during and after filling of the water reservoirs 55. The water supply connection 52 of the charging station 23 and the water feed connection 51 of the manure removing vehicle 6 are coupled automatically to supply water to the water system 50 when the manure removing vehicle 6 enters the charging station 23. On coupling of the water feed connection 51 of the manure removing vehicle 6 to the water supply connection 52 of the charging station 23, the water coupling opens automatically so that water is fed to the water reservoirs 55 of the manure removing vehicle 6. The water coupling comprises for example a mechanically controllable valve device (not shown). While the manure removing vehicle 6 is being charged in the charging station 23, the water system 50 can be filled with water.

The water supply connection 52 is installed in such a way that as the manure removing vehicle 6 travels forward into the charging station 23, water coupling only takes place after the primary coil 25 of the transmitting body 24 and the secondary coil 27 of the receiving body 26 are mutually aligned in the charging state. In other words, as the manure removing vehicle 6 enters the charging station 23, first the charging state is reached, and then the manure removing vehicle 6 continues to travel forward into the charging station 23, so that water coupling takes place automatically for supplying water to the water reservoirs 55. The charging state is maintained, even if the manure removing vehicle 6 abuts against the buffers 46 (see FIGS. 5D and 6F).

Water is supplied for as long as the coupling between the water feed connection 51 of the manure removing vehicle 6 and the water supply connection 52 is maintained. After the water reservoirs 55 have been substantially completely filled with water, the water feed connection 51 of the manure removing vehicle 6 is decoupled by travelling back a small distance, for example about 10-15 cm, within the charging station 23. The connection to the water supply connection 52 of the charging station 23 is then broken, so that the water coupling closes automatically. The charging state is maintained during the backward travel of the manure removing vehicle 6 (see FIGS. 5E and 6G).

Charging of the battery system 11 takes much longer than filling of the water reservoirs 55. If the water coupling were to be maintained for the complete charging time, there would be a risk of water wastage through leakage. By making it possible for the water feed connection 51 to be decoupled from the water supply connection 52 while wireless charging is in progress, the risk of high water consumption through leakage is practically excluded.

After the control system 9 has detected that the battery system 11 is charged sufficiently, the manure removing vehicle 6 travels out of the charging station 23. In this exemplary embodiment the manure removing vehicle 6 first moves back further, and then turns sideways away from the charging station 23. When the manure removing vehicle 6 has left the charging station 23, the transmitting body 24 is returned to the waiting state as a result of the pretension of the spring 33. The transmitting body 24 is then relocated in this waiting state in the same accurately defined position. Whenever the battery system 11 of the manure removing vehicle 6 (or of a second or further manure removing vehicle) has to be charged, alignment can take place reliably.

The invention is not limited to the exemplary embodiment shown in the figures. A person skilled in the art can make various adjustments that are within the scope of the invention. In particular the manure feed device of the manure removing vehicle may be configured differently. Instead of sucking up manure as described above, the manure feed device may comprise a mechanical scooping mechanism for scooping up manure from the floor. It is also possible for the manure removing vehicle to comprise two separate openings for feed or discharge of manure, respectively, i.e. a manure feed opening and a manure discharge opening. The manure is then for example moved upward by means of a rotary feed, and goes via the manure feed opening into the interior of the manure storage container. The manure can be discharged via the manure discharge opening. With a manure removing vehicle of this kind, a water system may also optionally be used for wetting the floor as described above.

1. A system for removing manure from a floor in a barn for animals, comprising:
an autonomous manure removing vehicle, comprising:
a drive system for driving the manure removing vehicle, the drive system being provided with at least one electric drive motor;
an electronic control system connected to the drive system for control thereof; and
a battery system for storing electrical energy, which battery system is connected to the drive system and the control system; and
a charging station for charging the battery system of the manure removing vehicle,
wherein the charging station comprises a transmitting body comprising a primary coil, and the manure removing vehicle comprises a receiving body comprising a secondary coil,
wherein the receiving body is arranged on a top side of the manure removing vehicle, and
wherein the manure removing vehicle is maneuverable with respect to the transmitting body of the charging station in such a way that the primary coil of the transmitting body and the secondary coil of the receiving body are mutually aligned in order to wirelessly transfer electrical energy from the primary coil to the secondary coil for wireless charging of the battery system of the manure removing vehicle.

2. The system as claimed in claim 1, wherein the transmitting body of the charging station comprises a downwardly facing flat surface,
wherein the receiving body of the manure removing vehicle comprises an upwardly facing flat surface, and
wherein the transmitting body of the charging station and the receiving body of the manure removing vehicle are arranged in such a way that the downwardly facing flat surface of the transmitting body of the charging station is arrangeable over and/or on top of the upwardly facing flat surface of the receiving body of the manure removing vehicle.

3. The system as claimed in claim 1, wherein the top side of the manure removing vehicle is defined by a substantially flattened top surface, and
wherein the receiving body extends along said top surface, wherein the flattened top surface defines a maximum height of the manure removing vehicle of between 50 and 80 cm.

4. The system as claimed in claim 1, wherein the receiving body is arranged in a vertical central longitudinal plane of the manure removing vehicle.

5. The system as claimed in claim 1, wherein the manure removing vehicle comprises a housing, in which the control system and/or the battery system are at least partly arranged, and
wherein the receiving body, viewed in a vertical direction, extends at least partly directly above the housing.

6. The system as claimed in claim 5, wherein the housing is provided with an access opening in order to make the interior thereof accessible, and a cover is movable between a closed position, in which the access opening is closed by the cover, and an open position, in which the interior of the housing is accessible via the access opening, and
wherein the access opening and the cover extend on the top side of the manure removing vehicle and the receiving body is provided on the cover.

7. The system as claimed in claim 1, wherein the transmitting body is arranged on the charging station at a distance above the floor.

8. The system as claimed in claim 7, wherein the transmitting body of the charging station is situated at a height which is adapted in such a way to the height of the receiving body of the manure removing vehicle that, by maneuvering the manure removing vehicle in the charging station, the transmitting body of the charging station is engageable by the receiving body of the manure removing vehicle, and the transmitting body and the receiving body are arrangeable over and/or on top of one another in order to wirelessly transfer electrical energy from the primary coil of the transmitting body to the secondary coil of the receiving body.

9. The system as claimed in claim 8, wherein the receiving body is fastened rigidly to the manure removing vehicle, and
wherein the transmitting body of the charging station is movable from a waiting state by engaging with the receiving body of the manure removing vehicle which enters the charging station, in such a way that the primary coil of the transmitting body and the secondary coil of the receiving body are aligned above one another in a charging state in order to wirelessly transfer electrical energy from the primary coil to the secondary coil.

10. The system as claimed in claim 1, wherein the primary coil of the transmitting body and the secondary coil of the receiving body are at a distance apart which is less than 5 cm, when the primary coil of the transmitting body of the charging station and the secondary coil of the receiving body of the manure removing vehicle are aligned over one another in order to wirelessly transfer electrical energy from the primary coil to the secondary coil.

11. The system as claimed in claim 1, wherein the manure removing vehicle comprises a manure slider for moving manure over the floor.

12. The system as claimed in claim 1, wherein the manure removing vehicle is provided with a manure storage container, a manure discharge opening for discharging manure from the manure storage container, and a manure feed device for feeding manure from the floor and moving the fed-in manure to the manure storage container.

13. The system as claimed in claim 12, wherein the charging station is provided with a dump opening in the floor for dumping manure from the manure discharge opening of the manure storage container through the dump opening into a manure reservoir which extends under the floor.

14. In combination, a barn for keeping animals, the system as claimed in claim 1.

15. A method for removing manure from a floor in a barn for animals, in which use is made of the system as claimed in claim 1, and wherein the method comprises:
moving the autonomous manure removing vehicle across the floor of the barn in order to remove manure from the floor;
moving the manure removing vehicle to the charging station; and
wirelessly charging the battery system of the manure removing vehicle in the charging station by wirelessly transmitting electrical energy from the primary coil of the transmitting body of the charging station to the secondary coil of the receiving body of the manure removing vehicle.

16. The system as claimed in claim 1, wherein the top side of the manure removing vehicle is defined by a substantially flattened top surface, and
wherein the receiving body extends along said top surface, wherein the flattened top surface defines a maximum height of the manure removing vehicle of 60 or 70 cm.

17. The system as claimed in claim 2, wherein the top side of the manure removing vehicle is defined by a substantially flattened top surface, and
wherein the receiving body extends along said top surface, wherein the flattened top surface defines a maximum height of the manure removing vehicle of between 50 and 80 cm.

18. The system as claimed in claim 2, wherein the receiving body is arranged in a vertical central longitudinal plane of the manure removing vehicle.

19. The system as claimed in claim 3, wherein the receiving body is arranged in a vertical central longitudinal plane of the manure removing vehicle.

20. The system as claimed in claim 2, wherein the manure removing vehicle comprises a housing, in which the control system and/or the battery system are at least partly arranged, and
wherein the receiving body, viewed in a vertical direction, extends at least partly directly above the housing.
